(19) United States
(12) Patent Application Publication
(10) Pub. No.: US 2003/0098051 A1
(43) Pub. Date: May 29, 2003

(54) Detachable knee or lower leg support system for crutches

(76) Inventor: Peter Fismer, St. Peter-Ording (DE)

Correspondence Address: Dr. Peter Fismer, Westerwohld 21, St. Peter-Ording, 25826, DE

(21) Appl. No.: 09/991,675

(22) Filed: Nov. 26, 2001

(51) Int. Cl. A45B 3/00; A45B 5/00; A61H 3/02; A45B 9/00

(52) U.S. Cl. 135/66; 135/68; 135/74; 135/75

(57) ABSTRACT

A detachable knee or lower leg support system for crutches which reduces the walking and standing effort when one lower leg or foot has to be protected from weightbearing. The system comprises 1. a cushioned support which can be fixed as required to a crutch by one or several clamp elements and 2. a rest element which should be used in elbow or forearm crutches for greater safety. The rest element is not required in axillary crutches. It pushes against the thigh or lower torso of the user and provides additional stability by securing a parallel alignment of crutch and thigh.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

1. Field of Invention

The invention relates to a detachable knee support which can be attached to a conventional forearm, elbow, or axillary crutch of single-tube design. When the flexed knee of the user is placed onto a padded support area, the whole lower leg can be protected from weight bearing without having to put weight onto the arms instead. This is advantageous for users suffering from impaired arm function and it allows a relaxed posture on both legs while standing. In addition, the invention allows the use of a single crutch for a fully weight protecting gait and it provides means to use the arm freely when assuming a stationary standing posture.

2. Description of Prior Art

The idea to use a knee or lower leg support as a weight protecting means in foot or lower leg diseases is not new. A 1568 painting by Pieter Bruegel the Elder, “The Beggars” (Louvre, Paris) depicts several wooden crutches with lower leg supports, and other later paintings by different artists show wooden axillary crutches with knee or lower leg rests. U.S. Pat. No. 751,942 (J. A. Renno, 1904) describes a wooden axillary crutch with adjustable handle and adjustable knee pad; U.S. Pat. No. 2,495,889 (C. R. Connaghan, 1950) describes a clamp (“detachable crutch bracket”) securing a leg support to an axillary crutch, and U.S. Pat. No. 2,678,054 (O. Bostelman, 1954) describes an axillary crutch with flexible and adjustable lower leg support.

Some other patents and patent applications describe axillary crutch improvements and a leg support which can be attached to axillary, forearm or elbow crutches by screws which are placed through drill holes (Pat. Application No. US 2001/0032661 A1).

What is lacking is an easy-to-use detachable knee support which fits readily onto modern, standardised crutches with single aluminum or steel tubing, which does not need crutch modifications (e.g. drill holes, welding spots or glue) and which can be adjusted to any desired height to meet the individual requirements of the user.

When such a support is used in axillary crutches, a secure standing position can be assumed because the crutch is stabilized at the armpit and can only move when the torso is moved.

In forearm or elbow crutches, the situation is more difficult as the standing position is less secure and requires a firm grip of the handle. In rapid gait, there is a certain danger that the user extends his elbow too much; in such a situation, control of the crutch gets easily lost because the tip is jammed against the floor and the body weight on the knee support tends to pull the crutch out of the user's hand and his overextending elbow.

It is therefore recommendable to provide an additional means of stability when a knee or lower leg support is used together with a forearm or elbow crutch instead of an axillary crutch. Until now, such a stabilizing component has not been described or suggested.

### BRIEF SUMMARY OF THE INVENTION

The present invention provides a detachable knee or lower leg support which is fixed to the upright member of a conventional crutch by one or several clamps. It is therefore not necessary to make use of drill holes. The crutch is left unchanged and can be used without the support once sufficient weight bearing has become possible.

As an additional means of stability, a suitable rest element at upper thigh level should be used in elbow or forearm crutches to provide a firm rest for the crutch both during gait and when standing. The present invention includes this additional feature.

Such a rest can assume a wide variety of shapes. A preferred embodiment of the additional rest element uses a curved tube which is attached to the crutch at right angles with respect to each tube's longitudinal axis by means of a clamp and which secures the crutch by pushing against the user's thigh from the front. It is described and depicted in more detail in the following sections. The rest allows to use the arm freely when assuming a stationary standing posture.

The advantages of knee or lower leg supports over the use of two conventional crutches and a non-weightbearing three-point gait have been described in many previous patents dealing with this subject, so that they do not have to be repeated here. In summary, a support puts less stress on the arms (wrists, elbows, shoulders) or, in axillary crutches, on the armpits, and it requires far less muscular strength for a non-weightbearing gait.

### BRIEF DESCRIPTION OF THE SEVERAL VIEWS OF THE DRAWING

FIGS. 1A,B,C illustrate three different load situations in an elbow crutch equipped with a knee support.

FIG. 1A shows the effect of the moment which develops when a downward force (body weight) is applied at the support. As this force is countered by an offset reaction force (counter force at tip of crutch), a moment is generated which pushes the crutch against the user's hip.

FIG. 1B shows the unstable situation in an elbow crutch without rest element. The top of the crutch tends to wobble back and forth as indicated.

FIG. 1C shows how the rest element of this invention stabilizes the crutch when said rest is pushed against the thigh. When the knee is held relaxed, the weight of the foot creates a moment which pushes the rest against the thigh as indicated.

FIG. 2 shows the knee support used in a Shepherd's crutch (axillary crutch) and, together with the rest element, in an elbow crutch.

FIG. 3 shows a perspective and an explosion view of an examplary knee support element. The four main components are identified by numbers 30-33.

FIG. 4 shows a top and perspective view of an examplary rest element.

### DETAILED DESCRIPTION OF THE INVENTION

The present invention consists of two parts: a detachable knee or lower leg support which can be clamped to the tubular post of a conventional forearm, elbow or axillary crutch and a rest element which is not required in axillary crutches, but should be used together with a support in all forearm or elbow crutches.

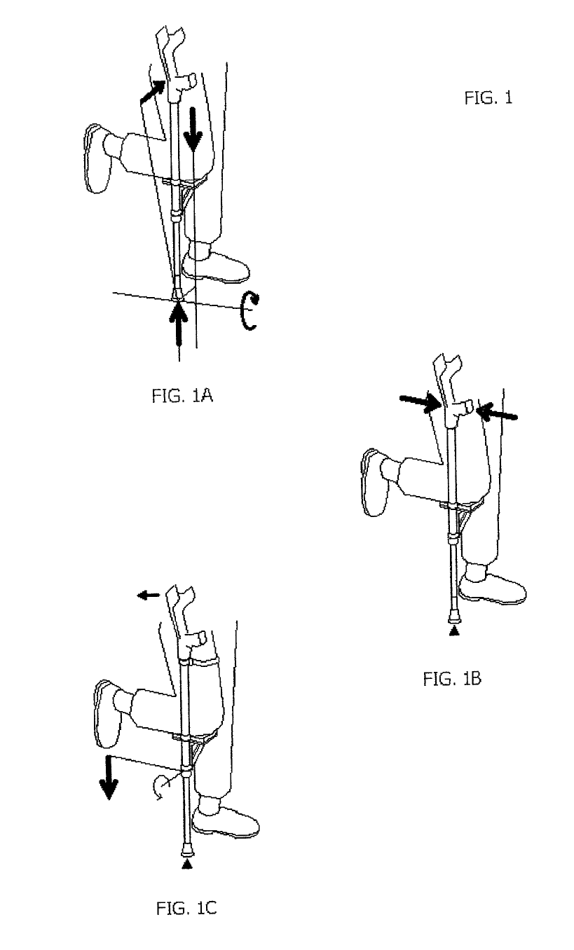

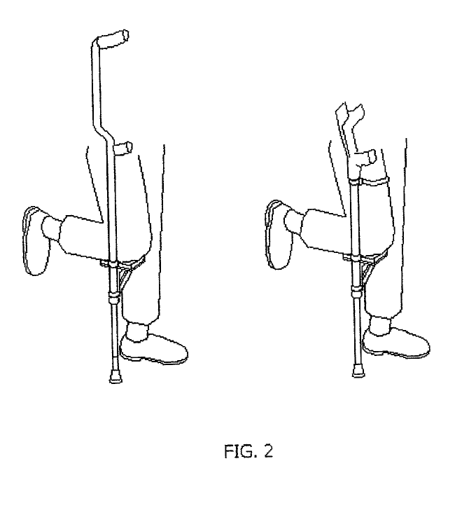

Such a rest element makes walking safer and standing easier because it provides a comparatively stable support point similar to the armpit in axillary crutches. Otherwise, the user is confined to using the grip and forearm rest of the crutch, which makes a fairly unstable support point; the upper crutch is pushed against the body when the knee is pushed onto its support (FIG. 1A), but it can still move forward and backward and has to be held parallel to the long axis of the thigh by an active balancing effort (FIG. 1B). With a rest element, a simple push of the rest against the thigh instead of a balancing action is all that is necessary to maintain control of the crutch (FIG. 1C). Therefore, loss of control is less likely to occur when the user's attention is distracted from the pure walking action. In the stationary standing position, the rest element is automatically pushed against the thigh when some of the body weight is put onto the leg support. When the knee is held relaxed, the weight of the foot creates a moment which pushes the rest against the thigh as indicated.

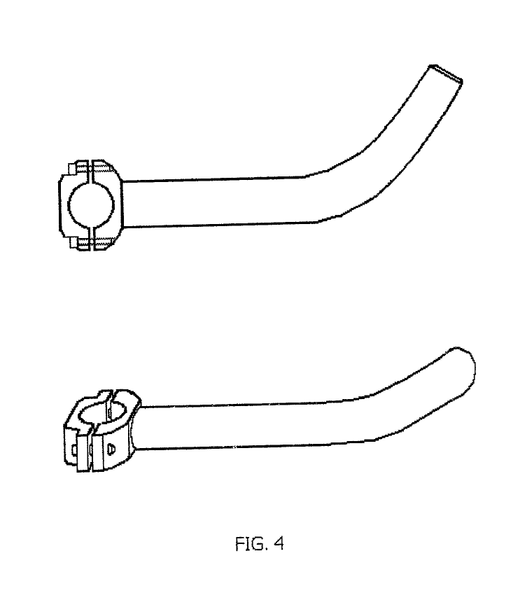

The rest element can be designed in very different ways. It may push against the thigh from the front or the back. The preferred embodiment uses a push from the front and consists of a curved tube attached to the crutch by means of a clamp (FIG. 4). The element can be adjusted to fit either leg by removing the clamp, rotating said tube around its long axis and reattaching the clamp again.

As mentioned above, the rest element is not required in axillary crutches. Most previous inventions related to knee or lower leg supports in axillary crutches, so that the need for an additional means of stability in shorter crutches was overlooked until now.

Together with the rest element described above, the knee support of the present invention provides a system which can be used in a large variety of crutches.

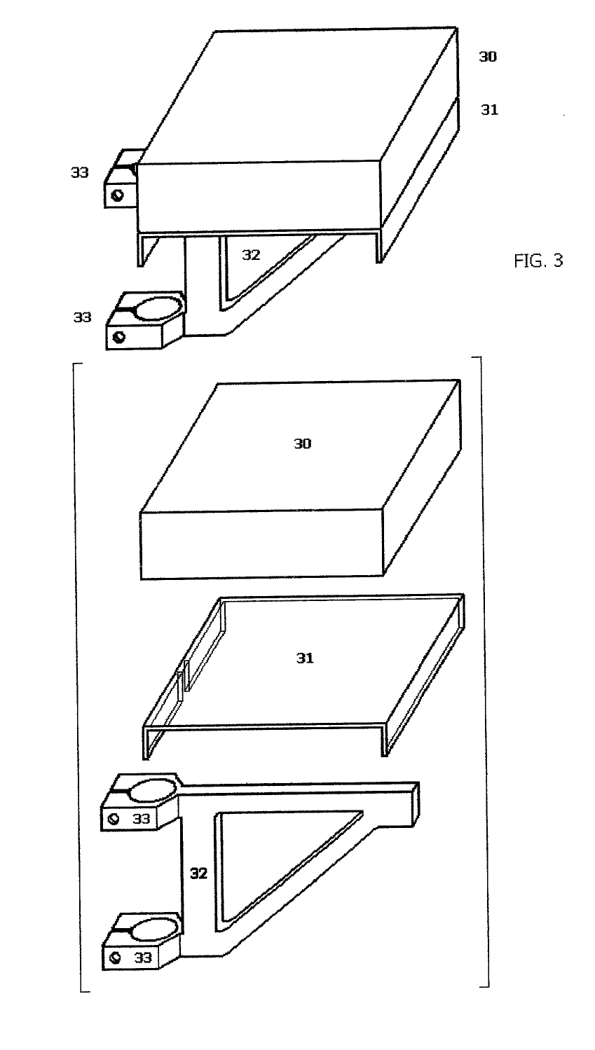

The knee support element consists of several typical components. A preferred embodiment is shown in FIG. 3; the components are:

a) A padded cushion 30—this cushion may have several shapes. It is fixed to the remaining parts of the support by velcro or other suitable means. The cushion may be moulded, custom made, rounded or shaped and padded in any other suitable design.

b) A cushion bearing plate 31—this plate may be perforated to reduce weight and it may be inclined or curved to allow the use of knee flexion angles smaller than 90°.

c) A plate holder 32—this holder is aligned parallel to the long axis of the crutch. It is the main connecting element between the clamp component or components and the plate 31. The holder is usually equipped with a diagonal support bar running to the lateral part of the plate from below, but this is not an essential feature. If components 31 and 32 are made of sufficiently stiff and strong material, the holder can assume any other suitable shape.

d) One or several clamp elements 33. These clamps are an essential feature of the present invention. They are connected to or are part of the plate holder 32 and allow a firm but detachable fixation to a tubular crutch post. The point of fixation at the crutch can be chosen as desired and changed at will, allowing an easy adjustment to individual limb lengths.

What I claim as my invention is:

1. A leg support comprising
a padded cushion serving as support for the flexed knee or a part of the lower leg
a cushion bearing plate with a suitably shaped surface onto which said cushion can be placed and fixed
a plate holder to which said cushion bearing plate is fixed
one or several clamp elements which are fixed to said plate holder and which allow a firm but detachable fixation of said leg support to the upright member of a crutch.

2. A rest element which can be used together with a leg support for crutches comprising
a fixation component which allows a sufficiently stable fixation of said rest element to the upright member of a crutch
a push component which pushes against the thigh or torso from the front or the back side of a person using a crutch equipped with said leg support when said person exerts a suitable force on said crutch.

3. A rest element which can be used together with a leg support for crutches comprising
a push component protruding from the handle portion or the upright member of a crutch, so that said push component pushes against the thigh or torso from the front or the back side of a person using said crutch when said person exerts a suitable force on said crutch.
